(19) United States
(12) Patent Application Publication
(10) Pub. No.: US 2023/0023196 A1
(43) Pub. Date: Jan. 26, 2023

(54) BAG HOLDER FOR FREEZING, THAWING, AND SHIPPING

(71) Applicant: ENTEGRIS, INC., Billerica, MA (US)

(72) Inventor: Nicholas Coscia, Lexington, MA (US)

(21) Appl. No.: 17/871,579

(22) Filed: Jul. 22, 2022

Related U.S. Application Data
(60) Provisional application No. 63/224,572, filed on Jul. 22, 2021.

(51) Int. Cl. A01N 1/02; F25D 29/00; B01L 9/00

(52) U.S. Cl. CPC A01N 1/0273; F25D 29/00; B01L 9/00; B01L 2200/185

(57) ABSTRACT

A bag holder for supporting a bioprocess bag during freezing includes a cover, a bottom, a frame, and at least one bag support. The cover, the bottom, and the frame form an enclosed space. The at least one bag support is disposed in the space. The cover and the bottom are made of metal. The frame has a first side, a second side, a front end, and a back end. Each of the cover and the bottom has a first bendable tab and a second bendable tab configured to bend over the front end from a longitudinal direction to a thickness direction, and a first arm and a second arm extending in the thickness direction and then in the longitudinal direction. Each of the first side and the second side includes at least one recessed portion extending in the longitudinal direction.

### FIELD

This disclosure is directed to bag holders for supporting bags during freezing, thawing, and/or frozen shipping processes, particularly bag holders providing retention and handling features along a periphery of the bag holders.

### BACKGROUND

Chemical and/or biological processes can be carried out, or their results contained in bags such as bags containing pharmaceutical or biological fluids, bioprocess bags, and the like. Process materials or materials resulting from the process may need to be frozen or otherwise kept at low temperature. Bags may need to be supported through cooling or freezing processes to ensure the integrity of the bag or maintenance of a desirable shape. Holders may be used to support and shape the bags before, during, and/or after the cooling or freezing process.

### SUMMARY

This disclosure is directed to bag holders for supporting bags during freezing, thawing, and/or frozen shipping process, particularly bag holders providing retention and handling features along a periphery of the bag holders.

An ongoing problem in the bioprocess market is at the freezing and/or thawing portion of process, where bag failures occur regularly when the bag freezes and/or when the bag filled with liquid product is frozen shipping to another facility for continued processing and packaging. A robust solution is needed to achieve optimum freeze rates, freezing density, frozen storage density, shipping density, and/or robust protection.

A particular type of bags (e.g., made of fluoropolymer or the like) is commonly used for e.g., plate freezing and thawing applications, while typical bag holders are designed and built around the need of polyethylene (PE) bags that have more elasticity than the fluoropolymer bags. This may result in the fluoropolymer bags experiencing multiple failures in the typical bag holders, which may deter users from using the fluoropolymer bags in the process.

To reduce the chance of fluoropolymer bag failures in the typical bag holders, the recommended fill range for the fluoropolymer bags may be set lower compared with recommended fill range for other bags.

Embodiments disclosed herein can provide solutions to the above problems by e.g., making the bag holder more robust, improving ease of use for users, allowing for robustness of the design and efficient thermal conductivity during e.g., plate freezing and thawing, incorporating bag support to immobilize bags and tubing while they are in their frozen state, and protecting the bags from impacts the bags sustain during handling and shipping.

Embodiment disclosed herein can also provide flexibility to modify the bag support configuration within the bag holder to improve the performance of the bag, utilizes less metal bend tabs compared with typical bag holders, make opening and closing the bag holder easier without reducing the effectiveness of the bag holder, provide additional reinforcement of the metal plates by configuring metal arms on the back side of the bag holder, and provide security features to the bag holders.

In an embodiment, a bag holder for supporting a bioprocess bag during freezing includes a cover, a bottom, a frame, and at least one bag support. The cover, the bottom, and the frame form an enclosed space. The at least one bag support is disposed in the space. The cover and the bottom are made of metal. The frame has a first side, a second side, a front end, and a back end. Each of the cover and the bottom has a first bendable tab and a second bendable tab configured to bend over the front end from a longitudinal direction to a thickness direction, and a first arm and a second arm extending in the thickness direction and then in the longitudinal direction. The cover and the bottom are removably attached to the frame. The frame is disposed between the cover and the bottom. Each of the first side and the second side includes at least one recessed portion extending in the longitudinal direction.

In an embodiment, the front end includes a first recess and a second recess extending in the thickness direction. The first recess is configured to accommodate the first tab of the cover and the first tab of the bottom. The second recess is configured to accommodate the second tab of the cover and the second tab of the bottom.

In an embodiment, the front end includes a first pin extending in the longitudinal direction from a concaved surface of the first recess, and a second pin extending in the longitudinal direction from a concaved surface of the second recess.

In an embodiment, the first tab of the cover includes a first hole. The first pin is configured to penetrate the first tab of the cover through the first hole. The second tab of the cover includes a second hole. The second pin is configured to penetrate the second tab of the cover through the second hole.

In an embodiment, the first tab of the bottom includes a third hole. The first pin is configured to penetrate the first tab of the bottom through the third hole. The second tab of the bottom includes a fourth hole. The second pin is configured to penetrate the second tab of the bottom through the fourth hole.

In an embodiment, each of the first pin and the second pin includes a through hole.

In an embodiment, the cover and the bottom are made of stainless steel. The frame is made of plastic.

In an embodiment, the frame is made of high density polyethylene.

In an embodiment, the front end includes a recessed portion extending in a width direction.

In an embodiment, the front end includes a first recess and a second recess extending in the thickness direction. The recessed portion of the front end is disposed between the first recess and the second recess in the width direction.

In an embodiment, the back end includes a recessed portion extending in a width direction. The recessed portion of the back end is disposed between the first arm and the second arm of the cover in the width direction.

In an embodiment, the front end includes a first side pin extending in a width direction from a first side surface of the front end, and a second side pin extending in the width direction from a second side surface of the front end. The back end includes a first side pin extending in the width direction from a first side surface of the back end, and a second side pin extending in the width direction from a second side surface of the back end.

In an embodiment, the first side includes a first through hole and a second through hole. The second side includes a first through hole and a second through hole. The first through hole of the first side is configured to accommodate the first side pin of the front end. The first through hole of the second side is configured to accommodate the second side pin of the front end. The second through hole of the first side is configured to accommodate the first side pin of the back end. The second through hole of the second side is configured to accommodate the second side pin of the back end.

In an embodiment, the at least one recessed portion of the first side includes two recessed portions arranged side by side along a length of the bag holder. The at least one recessed portion of the second side includes two recessed portions arranged side by side along the length of the bag holder.

In an embodiment, the first side includes a first longitudinal recess and a second longitudinal recess arranged in parallel to each other. The second side includes a first longitudinal recess and a second longitudinal recess arranged in parallel to each other.

In an embodiment, the cover includes a first longitudinal arm and a second longitudinal arm. The bottom includes a first longitudinal arm and a second longitudinal arm. The first longitudinal arm of the cover and the second longitudinal arm of the cover are configured to slide into the first longitudinal recess of the first side and the first longitudinal recess of the second side, respectively. The first longitudinal arm of the bottom and the second longitudinal arm of the bottom are configured to slide into the second longitudinal recess of the first side and the second longitudinal recess of the second side, respectively.

In an embodiment, a bag holder for supporting a bioprocess bag during freezing includes a cover, a bottom, a frame, and at least one bag support having an aperture. The cover, the bottom, and the frame form an enclosed space. The at least one bag support is disposed in the space. The cover and the bottom are made of metal. The frame has a first side, a second side, a front end, and a back end. Each of the cover and the bottom has a first bendable tab and a second bendable tab configured to bend over the front end from a longitudinal direction to a thickness direction, and a first arm and a second arm extending in the thickness direction and then in the longitudinal direction. The cover and the bottom are removably attached to the frame. The frame is disposed between the cover and the bottom. Each of the first side and the second side includes at least one recessed portion extending in the longitudinal direction. The bioprocess bag is disposed in the aperture.

In an embodiment, the bioprocess bag is made of fluoropolymer.

In an embodiment, a method of assembling a bag holder for freezing of a bioprocess bag is provided. The bag holder including a cover, a bottom, a frame, and at least one bag support. The frame has a first side, a second side, a front end, and a back end. The method includes inserting side pins of the front end and side pins of the back end into through holes of the first side and through holes of the second side; sliding the frame so that side arms of the bottom slide into a first longitudinal recess of the first side and a first longitudinal recess of the second side; bending tabs of the bottom into recesses of the front end so that pins of the front end penetrate the tabs of the bottom via holes of the tabs of the bottom; deploying at least one bag support into a space enclosed by the bottom and the frame; and sliding the cover so that side arms of the cover slide into a second longitudinal recess of the first side and a second longitudinal recess of the second side.

In an embodiment, the method also includes inserting the bag holder into a package, and vacuum sealing the package containing the bag holder.

### DRAWINGS

References are made to the accompanying drawings that form a part of this disclosure and which illustrate the embodiments in which systems and methods described in this specification can be practiced.

FIG. 1A illustrates an exploded view of a bag holder, according to an embodiment.

FIG. 1B is the bag holder of FIG. 1A viewed at a different angle, according to an embodiment.

FIG. 2A illustrates a perspective view of a bag holder, according to an embodiment.

FIG. 2B is the bag holder of FIG. 2A viewed at a different angle, according to an embodiment.

FIG. 3 illustrates a perspective view of a bag holder without the cover, according to an embodiment.

FIG. 4A illustrates a perspective view of a cover/bottom of a bag holder, according to an embodiment.

FIG. 4B illustrates a back end view of the cover/bottom of FIG. 4A, according to an embodiment.

FIG. 4C illustrates a side view of the cover/bottom of FIG. 4A, according to an embodiment.

FIG. 4D illustrates a top view of the cover of FIG. 4A, according to an embodiment.

FIG. 5A illustrates a perspective view of a bag support of a bag holder, according to an embodiment.

FIG. 5B illustrates a perspective view of two bag supports stacked together, according to an embodiment.

FIG. 5C illustrates a perspective view of a bag support of a bag holder, according to another embodiment.

FIG. 6A illustrates a perspective view of a front end of a frame of a bag holder, according to an embodiment.

FIG. 6B is the front end of FIG. 6A viewed at a different angle, according to an embodiment.

FIG. 6C is a top view of the front end of FIG. 6A, according to an embodiment.

FIG. 6D is a perspective view of a front end interacting with a bottom, according to an embodiment.

FIG. 7A illustrates a perspective view of a back end of a frame of a bag holder, according to an embodiment.

FIG. 7B is the back end of FIG. 7A viewed at a different angle, according to an embodiment.

FIG. 7C is a cross-sectional view of the back end of FIG. 7B along the line 7C-7C, according to an embodiment.

FIG. 7D is a cross-sectional view of the back end of FIG. 7B along the line 7D-7D, according to an embodiment.

FIG. 8A illustrates a perspective view of a side of a frame of a bag holder, according to an embodiment.

FIG. 8B is the side of FIG. 8A viewed at a different angle, according to an embodiment.

FIG. 8C is an end view of the side of FIG. 8A, according to an embodiment.

Like reference numbers represent like parts throughout.

### DETAILED DESCRIPTION

This disclosure is directed to bag holders for supporting bags during freezing, thawing, and/or frozen shipping process, particularly bag holders providing retention and handling features along a periphery of the bag holders.

As defined herein, the phrase “a plate freezing process” may refers to a process of freezing object(s) (e.g., bag holder(s) or the like) via e.g., plate freezer(s). A plate freezer can be e.g., a hollow plate that has liquid refrigerant flowing through it. Objects can be placed between two plates and evenly cooled to freezing temperatures. The plate freezers can be ideal for freezing flat objects or brick-shaped packaged objects.

As defined herein, the phrase “a blast freezing process” may refer to a process of freezing object(s) (e.g., bag holder(s) or the like) via e.g., blast freezer(s). A blast freezer can be e.g., a mechanical system generally used to freeze products in bulk on pallets. It will be appreciated that the phrase “a thawing process” may refer to a process designed to thaw objects instead of freezing objects.

Embodiments disclosed herein can provide a robust bag holder designed for plate freezing, blast freezing, and/or robust frozen shipping.

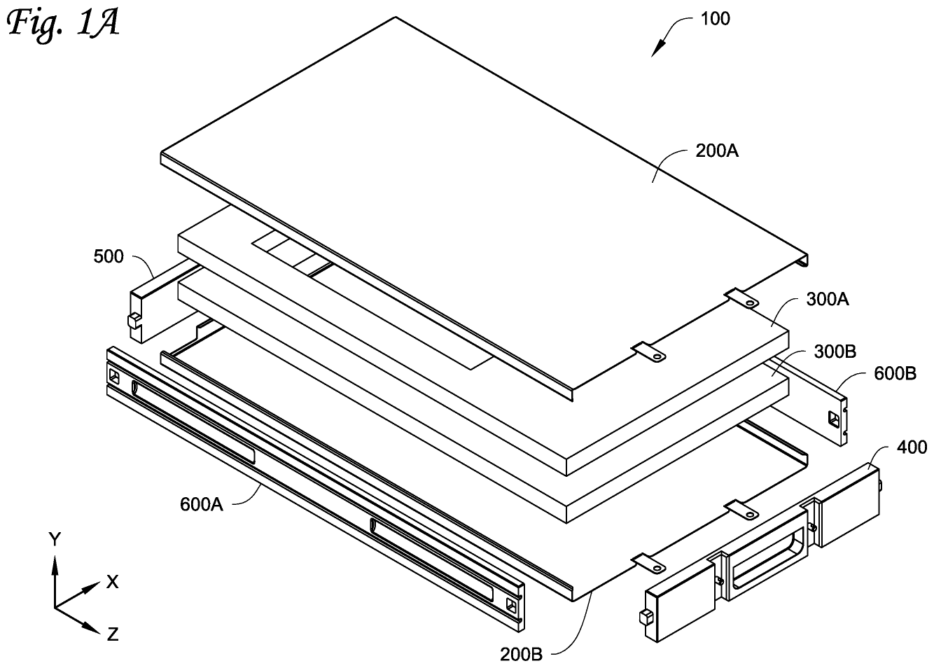

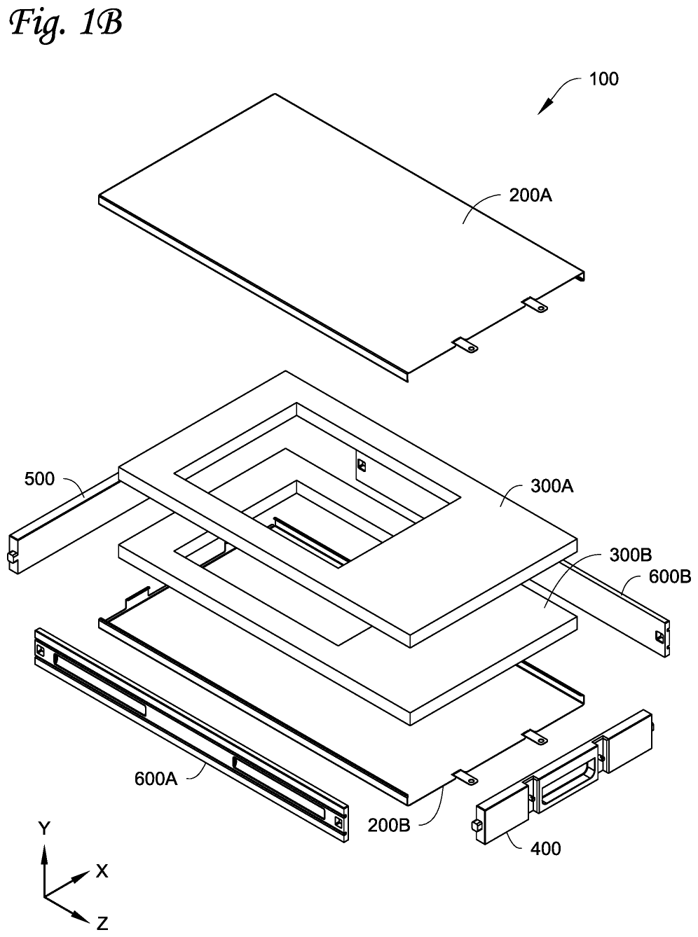

FIG. 1A illustrates an exploded view of a bag holder 100, according to an embodiment. FIG. 1B is the bag holder 100 of FIG. 1A viewed at a different angle, according to an embodiment.

As shown in FIG. 1A and 1B, the bag holder 100 includes a cover 200A, a bottom 200B, a frame (400, 500, 600A, 600B), and two bag supports (300A, 300B). In an embodiment, the cover and the bottom can be identical to each other. In an embodiment, the two bag supports can be identical to each other. It will be appreciated that the bag holder 100 can include at least one bag support (300A, 300B).

The frame (400, 500, 600A, 600B) includes a front end 400, a back end 500, a first side 600A, and a second side 600B. In an embodiment, the first side and the second side can be identical to each other.

As shown in FIG. 1A and 1B, the bag holder 100 has a thickness or height in a vertical direction (Y direction). The bag holder 100 has a width in a horizontal or transverse direction (X direction). The bag holder 100 has a length in a longitudinal direction (Z direction). As defined herein, the phrase “a thickness direction” may refers to the Y direction, indicating the thickness direction of the bag holder 100. The phrase “a width direction” may refers to the X direction, indicating the width direction of the bag holder 100. The phrase “a longitudinal direction” may refers to the Z direction, indicating the length direction of the bag holder 100.

When being assembled, in the thickness direction, the bag support 300B is disposed above the bottom 200B, the bag support 300A is disposed above the bag support 300B, and the cover 200A is disposed above the bag support 300A. The front end 400 is disposed generally in parallel with and is spacing apart from the back end 500. In an embodiment, a distance (in the longitudinal direction) between the front end 400 and the back end 500 generally is a length of the bag holder 100. The first side 600A is disposed generally in parallel with and is spacing apart from the second side 600B. In an embodiment, a distance (in the width direction) between the first side 600A and the second side 600B generally is a width of the bag holder 100.

In an embodiment, the cover 200A and/or the bottom 200B can be made of metal. In an embodiment, the metal can be steel such as stainless steel (e.g., Society of Automotive Engineers (SAE) 304 stainless steel, etc.) or the like. It will be appreciated that the material of the cover 200A and/or the bottom 200B can be any suitable material that provides sufficient robustness, is cost efficient, and provides sufficient thermal conduction. The bag holder 100 can be robust enough to handle e.g., being dropped after freezing without the bag holder or a bag contained therein experiencing severe damage such as breakage of the bag holder 100 or bursting or puncturing of the bag contained therein.

In an embodiment, the at least one bag support (300A, 300B) can be made of foam material. In an embodiment, the at least one bag support (300A, 300B) can be made of polyurethane. It will be appreciated that the material of the at least one bag support (300A, 300B) can be any suitable material that can tolerate a large range of temperatures (e.g., as low as at or about or below −85° C. without fracturing), be suitable for deforming to adjust to the geometry of the bag (not shown) in room temperature, serve as barrier to help immobilize the bag and serve as a cushion to the bag during the freezing, thawing, and/or shipping process.

In an embodiment, the frame (400, 500, 600A, 600B) can be made of plastic material. In an embodiment, the frame (400, 500, 600A, 600B) can be made of polyethylene (PE), high density polyethylene (HDPE), fluoropolymer, or any other suitable material. In an embodiment, the ends and/or sides of the frame (400, 500, 600A, 600B) can be machined to fit or interlock with or connect to each other. In another embodiment, the frame (400, 500, 600A, 600B) can use injection molding, cast molding (e.g., two-part cast molding or the like), thermoforming, or the like instead of machining to reduce manufacturing cost. It will be appreciated that the material of the frame (400, 500, 600A, 600B) can be any suitable material that provides sufficient robustness and/or ease of use in assembling.

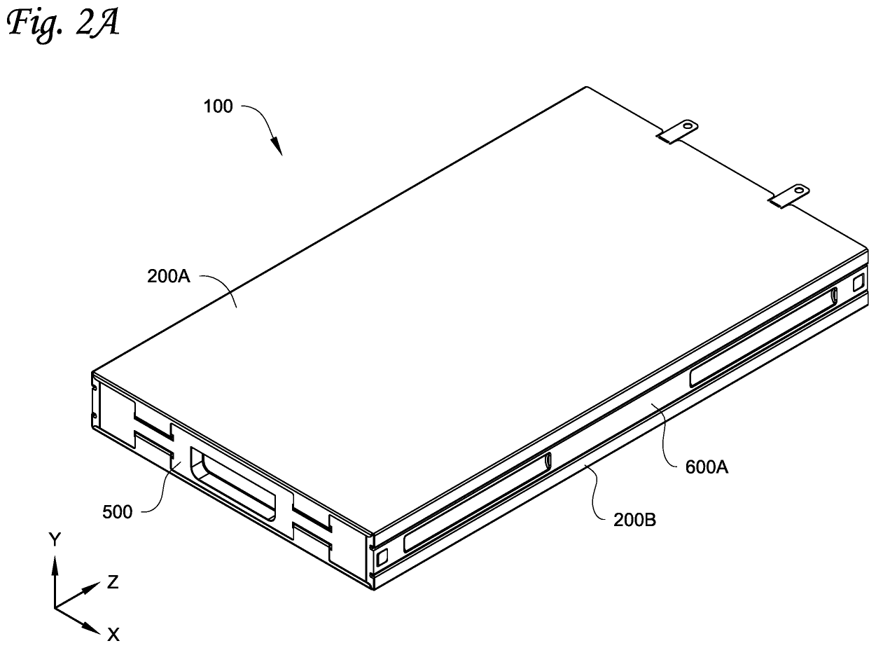

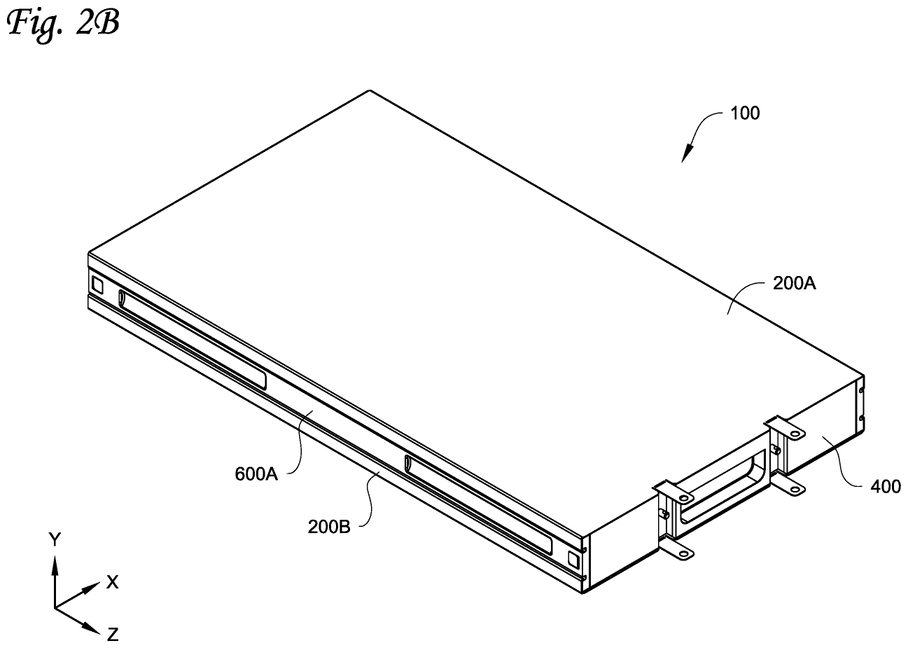

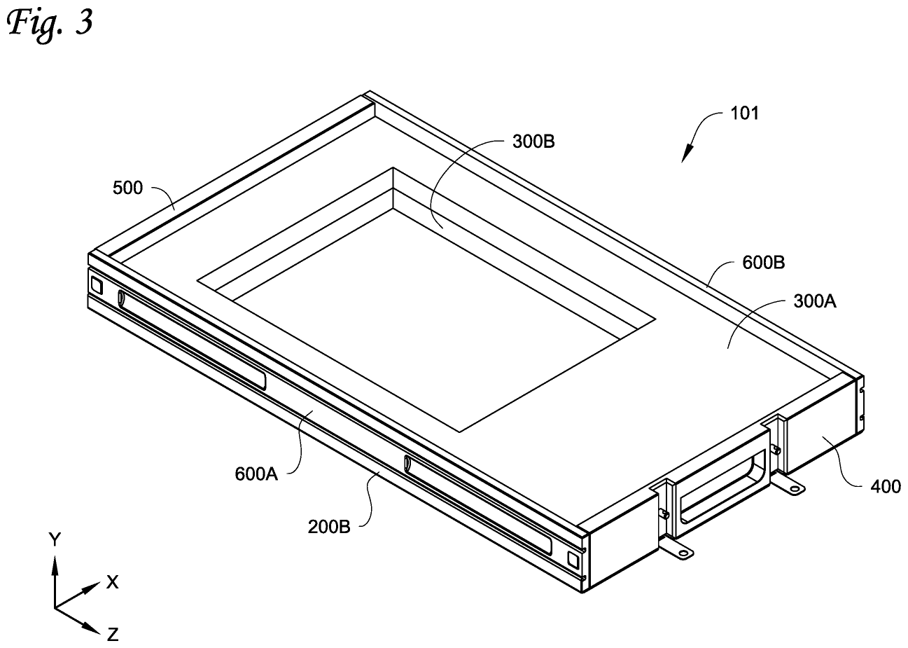

FIG. 2A illustrates a perspective view of a bag holder 100, according to an embodiment. FIG. 2B is the bag holder 100 of FIG. 2A viewed at a different angle, according to an embodiment. FIG. 3 illustrates a perspective view of a bag holder 101 without the cover, according to an embodiment.

As shown in FIGS. 2A and 2B, the bag holder 100 is at least partially assembled. The cover 200A and the bottom 200B are removably attached to the frame (400, 500, 600A, 600B). The frame (400, 500, 600A, 600B) is disposed between the cover 200A and the bottom 200B.

The cover 200A, the bottom 200B, and the frame (400, 500, 600A, 600B) form an enclosed space. As shown in FIG. 3, the at least one bag support (300A, 300B) is accommodated in the enclosed space. In an embodiment, the thickness or height of the at least one bag support (300A, 300B) is less than the thickness or height of the frame (400, 500, 600A, 600B) (and/or the thickness of the enclosed space). In another embodiment, the thickness or height of the at least one bag support (300A, 300B) can be the same as the thickness or height of the frame (400, 500, 600A, 600B) (and/or the thickness of the enclosed space).

In an embodiment, the bag holder 100 has generally a flat box shape (e.g., a rectangular cuboid, or the like) configured to facilitate e.g., the freezing, thawing, storage, and/or shipping process.

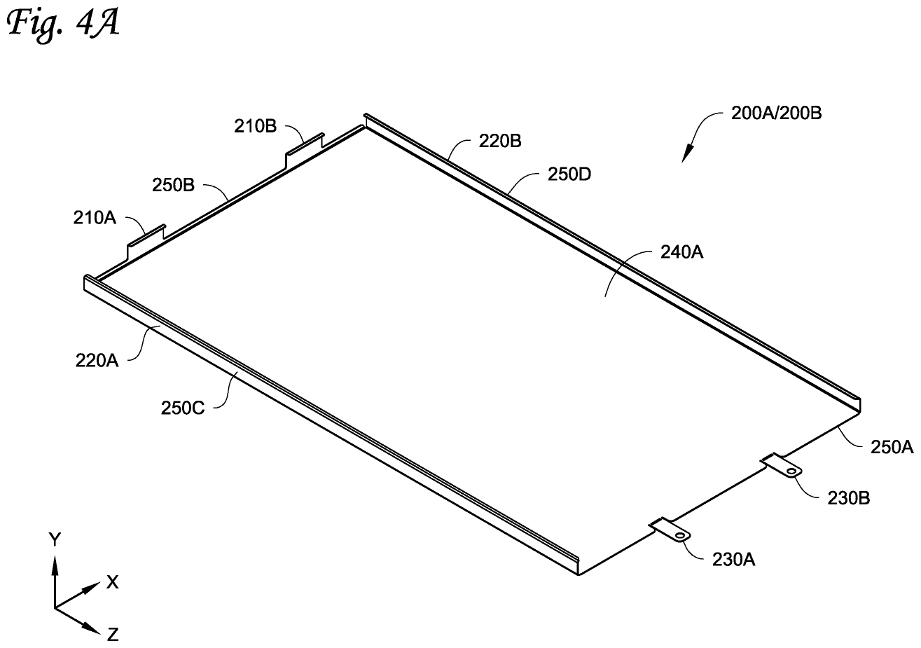

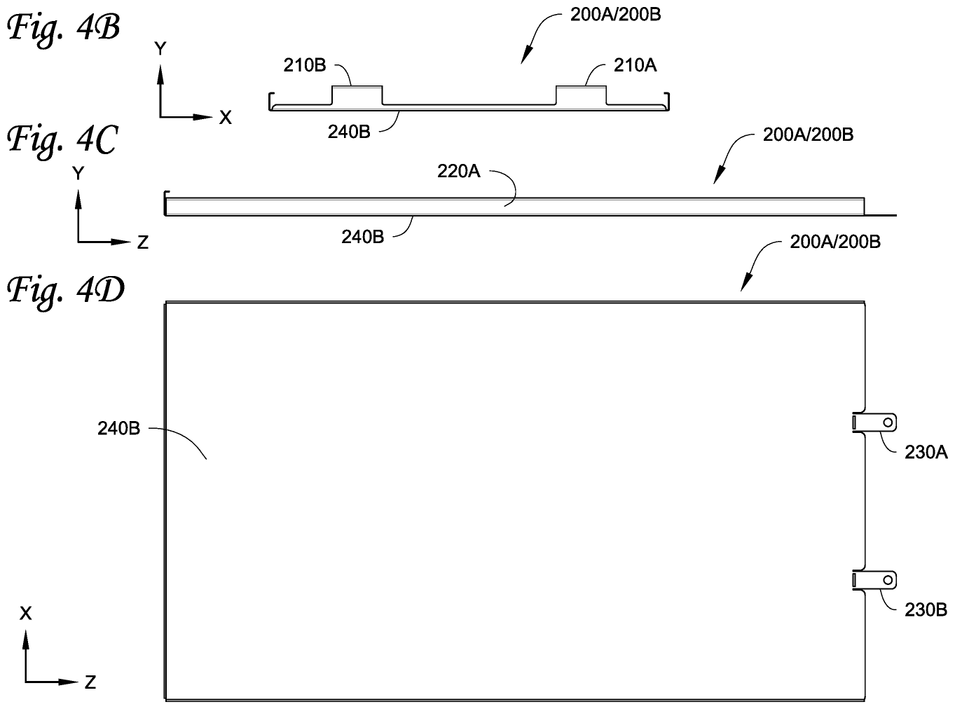

FIG. 4A illustrates a perspective view of a cover/bottom (200A, 200B) of a bag holder 100, according to an embodiment. FIG. 4B illustrates a back end view of the cover/bottom (200A, 200B) of FIG. 4A, according to an embodiment. FIG. 4C illustrates a side view of the cover/bottom (200A, 200B) of FIG. 4A, according to an embodiment. FIG. 4D illustrates a top view of the cover 200A (or a bottom view of the bottom 200B) of FIG. 4A, according to an embodiment.

It will be appreciated that in an embodiment, the cover and the bottom (200A, 200B) of the bag holder 100 can be identical to each other. As shown in FIGS. 4A-4D, the cover/bottom (200A, 200B) includes a flat surface 240B, which is a surface facing away from the enclosed space formed by the cover, the bottom, and the frame. The cover/bottom (200A, 200B) also includes a flat surface 240A, which is a surface facing towards the enclosed space. The flat surface 240B of the cover/bottom (200A, 200B) (e.g., made of metal) is designed/configured to facilitate e.g., the plate freezing or thawing process by, e.g., providing desired thermal conduction between outside (e.g., the plate freezer) and the enclosed space where a bag is disposed.

In an embodiment, the cover/bottom (200A, 200B) has four sides (250A, 250B, 250C, 250D). When the bag holder 100 is being assembled, each of the four sides (250A, 250B, 250C, 250D) corresponds to the front end 400, the back end 500, the first side 600A, and the second side 600B of the frame, respectively.

In an embodiment, on side 250A, the cover/bottom (200A, 200B) includes two tabs (230A, 230B). In another embodiment, the cover/bottom (200A, 200B) can include at least one tab (230A, 230B). It will be appreciated that except the location, the two tabs (230A, 230B) can be identical to each other. In an unassembled state, the tabs (230A, 230B) extend in the longitudinal direction (Z direction) away from the side 250A and away from the enclosed space. The tabs (230A, 230B) are spaced apart from the sides 250C and 250D, and are spaced apart from each other in the width direction (X direction). The tabs (230A, 230B) are configured to be bendable, preferably in the thickness direction (Y direction) towards the enclosed space. It will be appreciated that the phrase “bendable” may refer to a characteristic of capable of being bent or flexed or twisted without breaking. Each tab (230A, 230B) includes a through hole at a distal end of the tab (230A, 230B) away from the side 250A. The tabs (230A, 230B) are configured to work with the front end 400 of the frame (to be described later).

In an embodiment, on side 250B, the cover/bottom (200A, 200B) includes two arms (210A, 210B). In another embodiment, the cover/bottom (200A, 200B) can include at least one arm (210A, 210B). It will be appreciated that except the location, the two arms can be identical to each other. The arm(s) (210A, 210B) on the back of the cover/bottom (200A, 200B) are configured to retain the cover/bottom (200A, 200B) and prevent the cover/bottom (200A, 200B) from bowing during freezing and/or shipping. The arms (210A, 210B) are spaced apart from the sides 250C and 250D, and are spaced apart from each other in the width direction (X direction). The arms (210A, 210B) include a first protrusion (Y-protrusion) extending in the thickness direction (Y direction) away from the side 250B and towards the enclosed space, and a second protrusion (Z-protrusion) extending in the longitudinal direction (Z direction) away from a distal end of the first protrusion (Y-protrusion) and towards the enclosed space. The arms (210A, 210B) are configured to work with the back end 500 of the frame (to be described later).

In an embodiment, on side 250C, the cover/bottom (200A, 200B) includes a longitudinal arm 220A. The longitudinal arm 220A extends from the side 250A to the side 250B in the longitudinal direction (Z direction). The longitudinal arm 220A includes a first protrusion (Y-protrusion) extending in the thickness direction (Y direction) away from the side 250C and towards the enclosed space, and a second protrusion (X-protrusion) extending in the width direction (X direction) away from a distal end of the first protrusion (Y-protrusion) and towards the enclosed space. The longitudinal arm 220A is configured to work with the side (600A, 600B) of the frame (to be described later).

In an embodiment, on side 250D, the cover/bottom (200A, 200B) includes a longitudinal arm 220B. The longitudinal arm 220B extends from the side 250A to the side 250B in the longitudinal direction (Z direction). The longitudinal arm 220B includes a first protrusion (Y-protrusion) extending in the thickness direction (Y direction) away from the side 250D and towards the enclosed space, and a second protrusion (X-protrusion) extending in the width direction (X direction) away from a distal end of the first protrusion (Y-protrusion) and towards the enclosed space. The longitudinal arm 220B is configured to work with the side (600A, 600B) of the frame (to be described later). In an embodiment, except on different sides (250C, 250D) and facing each other in the width direction (X direction), the longitudinal arms (220A, 220B) can have the same configuration.

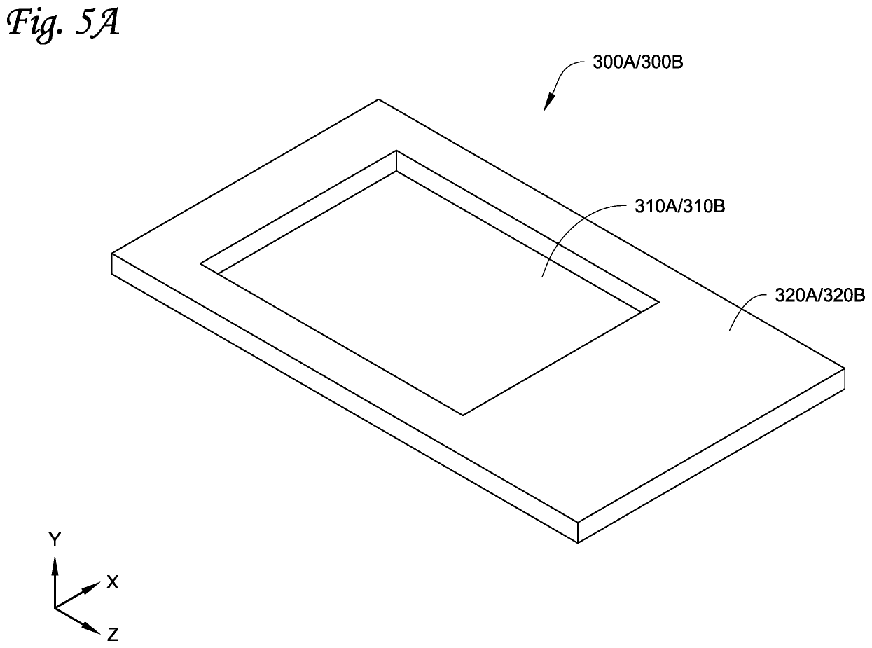

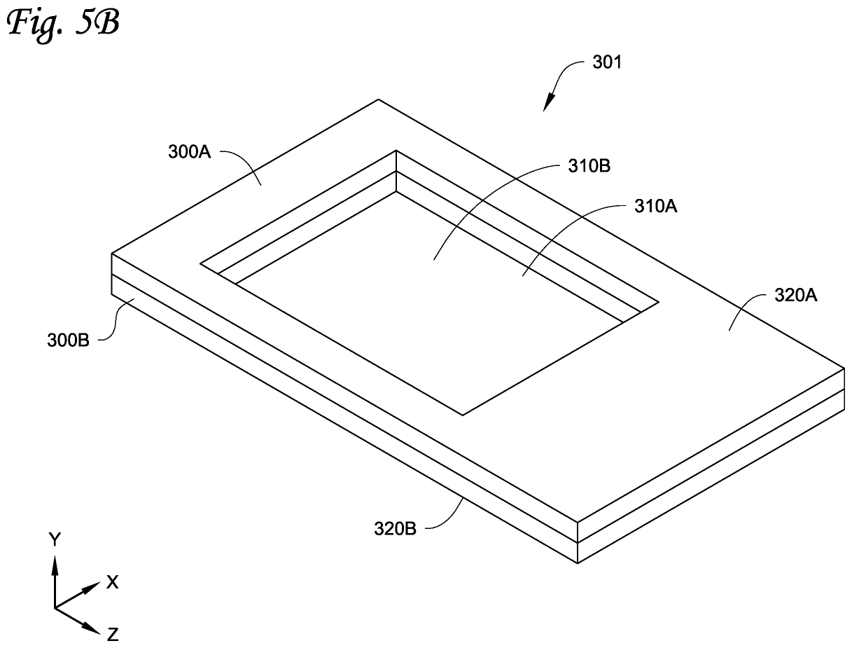

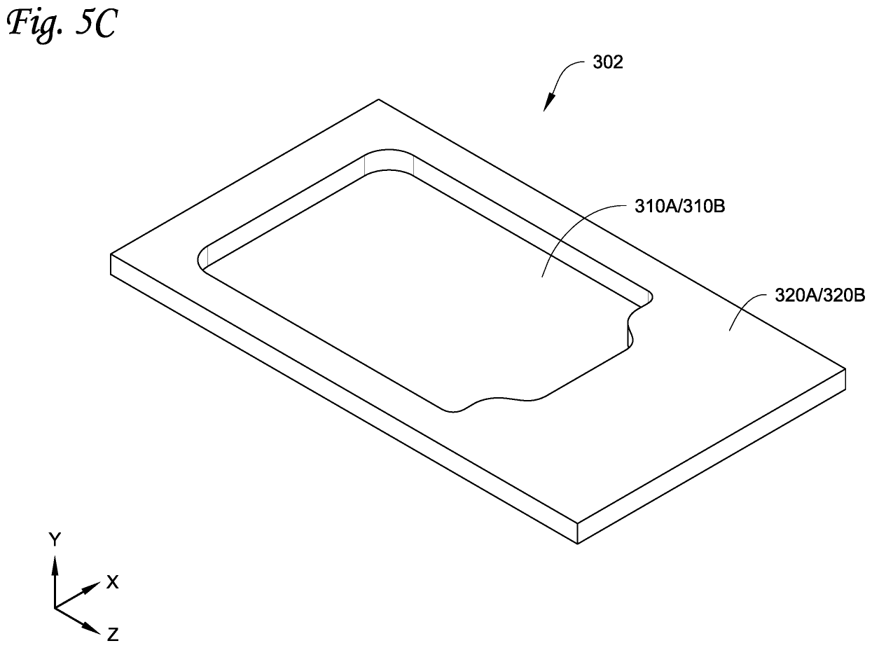

FIG. 5A illustrates a perspective view of a bag support (300A, 300B) of a bag holder 100, according to an embodiment. FIG. 5B illustrates a perspective view 301 of two bag supports (300A, 300B) stacked together, according to an embodiment. FIG. 5C illustrates a perspective view of a bag support 302 of a bag holder 100, according to another embodiment.

In an embodiment, the bag holder 100 can include at least one bag support (300A, 300B, 302). As shown in FIG. 5B, the bag holder 100 includes two bag supports (300A, 300B) identical to each other. The size and shape of the bag support(s) (300A, 300B, 302) are configured so that the bag support(s) (300A, 300B, 302) can be accommodated within the enclosed space formed by the cover 200A, the bottom 200B, and the frames (400, 500, 600A, 600B) without causing bowing on the bag support(s) (300A, 300B, 302). In an embodiment, the bag support(s) (300A, 300B, 302) can have a shape of a rectangular cuboid. It will be appreciated that the bag supports (300A, 300B, 302) can be designed/configured to fit in the bag holder 100 and retain a bag in place during freezing, shipping, and/or thawing processes. The bag support (300A, 300B, 302) (e.g., foam or the like) can be designed/configured to deform at ambient temperature and adjust to contours of the bag and the tubing connected to the bag. The bag support (300A, 300B, 302) can also be designed/configured to focus a fluid in the bag to an open area/cut section of the bag support (300A, 300B, 302) where the bag can have direct contact with the cover 200A and the bottom 200B of the bag holder 100. The bag support (300A, 300B, 302) can further be designed/configured to harden when frozen to act as a rigid object that can retain the bag and tubing in place while frozen.

In an embodiment, each bag support (300A, 300B, 302) includes an open (or empty) area (310A, 310B) surrounded by an area (320A, 320B). The size and shape of the open area (310A, 310B) are configured so that a bag can be accommodated within the open area. It will be appreciated that the open area/cut (310A, 310B) can mimic an outer perimeter of the bag (e.g., an Aramus bag from A4, In an embodiment, the open area (310A, 310B) can have a shape of a rectangular cuboid. As shown in FIG. 5B, the open areas (310A, 310B) of the bag supports (300A, 300B) overlap with each other. The areas (320A, 320B) of the bag supports (300A, 300B) overlap with each other. Referring to FIG. 3, a bag (not shown) can be accommodated in the open areas (310A, 310B) surrounded by the areas (320A, 320B) and contacting a region of the cover 200A and a region of the bottom 200B defined by the open areas (310A, 310B). The open area (310A, 310B) (length and width can be built around the needs of the bag) can be configured at where the fluid (e.g., refrigerant or the like) of the plate freezer may contact the metal plates, or the area (320A, 320B) can be configured at where the fluid (e.g., refrigerant or the like) is not contacting the metal plates.

In an embodiment, the bag (not shown) can be made of fluoropolymer. It will be appreciated that the bag can be made of any suitable material that has a desired level of purity suitable for e.g., drug application, that can tolerate a wide temperature range e.g., down to liquid nitrogen, and that is strong enough suitable for e.g., bioproces sing. In an embodiment, the material of the bag is not polyethylene (PE). In an embodiment, the bag is to be filled with a desired amount of product(s) to have contact on the cover and the bottom (200A, 200B) to ensure desired thermal conductivity. The open area (310A, 310B) can be designed so that the pressure on the bag (e.g., to force the bag to adjust into the geometry of the bag holder) may not be too strong to break the bag.

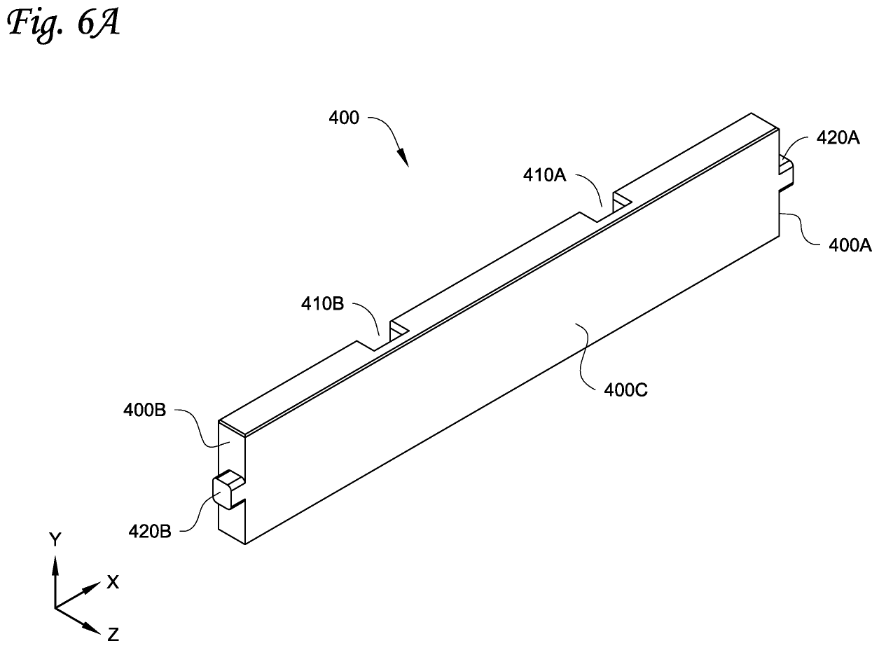

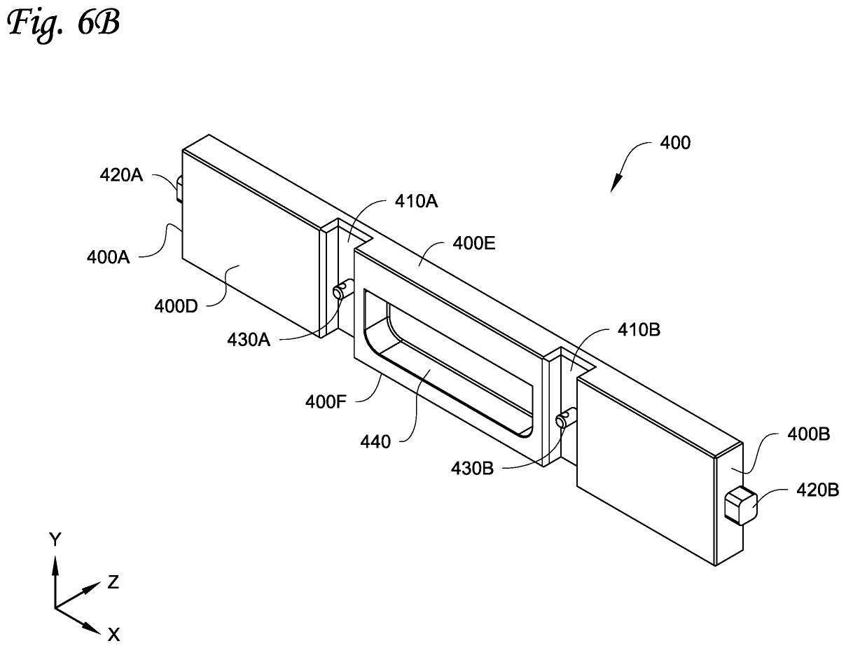

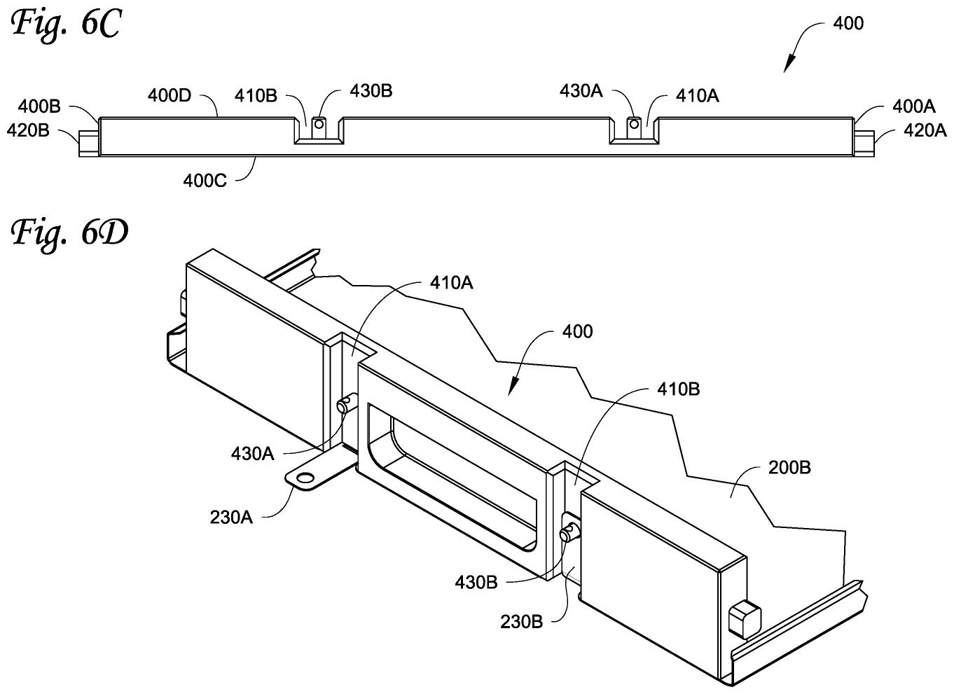

FIG. 6A illustrates a perspective view of a front end 400 of a frame (400, 500, 600A, 600B) of a bag holder 100, according to an embodiment. FIG. 6B is the front end 400 of FIG. 6A viewed at a different angle, according to an embodiment. FIG. 6C is a top view of the front end 400 of FIG. 6A, according to an embodiment. FIG. 6D is a perspective view of a front end 400 interacting with a bottom 200B, according to an embodiment.

In an embodiment, the front end 400 can have a shape of a rectangular cuboid with protrusions (420A, 420B) extending from e.g., a middle portion of end surfaces (400A, 400B), respectively. The front end 400 includes a generally flat main surface 400C facing towards the enclosed space, and another main surface 400D opposite to surface 400C in the Z direction. The front end 400 also includes two end surfaces (400A, 400B) opposite to each other in the X direction.

In an embodiment, on the end 400A, the front end 400 includes a protrusion 420A protruding from e.g., a middle portion of the surface of the end 400A in X direction. On end 400B, the front end 400 includes a protrusion 420B protruding from e.g., a middle portion of the surface of the end 400B in X direction opposite to the protrusion 420A. In an embodiment, the protrusions can be identical to each other except the location and/or direction. In an embodiment, each protrusion (420A, 420B) can be a pin. The protrusion (420A, 420B) is configured to work with the side (600A, 600B) of the frame (to be described later).

In an embodiment, on the main surface 400D, the front end 400 includes recesses (410A, 410B) extending in the thickness direction (Y direction) from a top surface 400E of the front end 400 to the bottom surface 400F. In an embodiment, the recesses (410A, 410B) can be identical to each other except the location. The recesses (410A, 410B) are spaced away from the ends (400A, 400B), and are spaced from each other. It will be appreciated that in FIG. 4A, the distances between the sides (250C, 250D) and the tabs (230A, 230B) correspond to the distances between the ends (400A, 400B) and the recesses (410A, 410B). In FIG. 4A, the distance between the tabs (230A, 230B) corresponds to the distance between the recesses (410A, 410B).

Back to FIGS. 6A-6D, the front end 400 includes a pin 430A extending from a concaved surface of the recess 410A in the longitudinal direction (Z direction) away from the enclosed space. The front end 400 also includes a pin 430B extending from a concaved surface of the recess 410B in the longitudinal direction (Z direction) away from the enclosed space. In an embodiment, the pins can be identical to each other except the location. Each pin (430A, 430B) can include a through hole near a distal end of the pin (430A, 430B). See FIG. 6C.

As shown in FIG. 6D, the tabs (230A, 230B) of the bottom 200B can be aligned with the recesses (430A, 430B), respectively. The bendable tabs 230 can be bent from the Z direction to the Y direction over the front end 400 so that the pins (430A, 430B) can penetrate the tabs (230A, 230B) through the holes of the tabs (230A, 230B). As shown in FIG. 6D, the tab 230B is bent over the front end 400 so that the pin 430B penetrates the tab 230B through the hole of the tab 230B. The tab 230B is then accommodated in the recess 410B generally perpendicular to the main surfaces (240A, 240B) of the bottom 200B. The tab 230B is disposed between the through hole of the pin 430B and the concaved surface of the recess 410B, so that no tabs are hanging out of the front end 400 to e.g., cut on gloves. Also a cable tie or the like can be installed through the through hole of the pin 430B to keep the bag holder 100 as a tamper evidence feature.

Similarly, the tab 230A can be bent over so that the pin 430A penetrates the tab 230A through the hole of the tab 230A. The tab 230A is then accommodated in the recess 410A generally perpendicular to the main surfaces (240A, 240B) of the bottom 200B. The tab 230A can be disposed between the through hole of the pin 430A and the concaved surface of the recess 410A, so that no tabs are hanging out of the front end 400 to e.g., cut on gloves. Also a cable tie or the like can be installed through the through hole of the pin 430A to keep the bag holder 100 as a tamper evidence feature. The tabs (230A, 230B) of the cover 200A are configured to work with the recesses (410A, 410B) and pins (430A, 430B) of the front end 400 in a similar way, so that the bag holder 100 can provide desired retention on the front.

In an embodiment, the front end 400 includes a recessed portion 440 extending in the width direction (X direction) and disposed between the recesses (410A, 410B) in the width direction (X direction). The recessed portion 440 is configured to facilitate users to grab/hold/handle the bag holder with their hands, when e.g., the bag holder 100 is in a box filled with dry-ice environment.

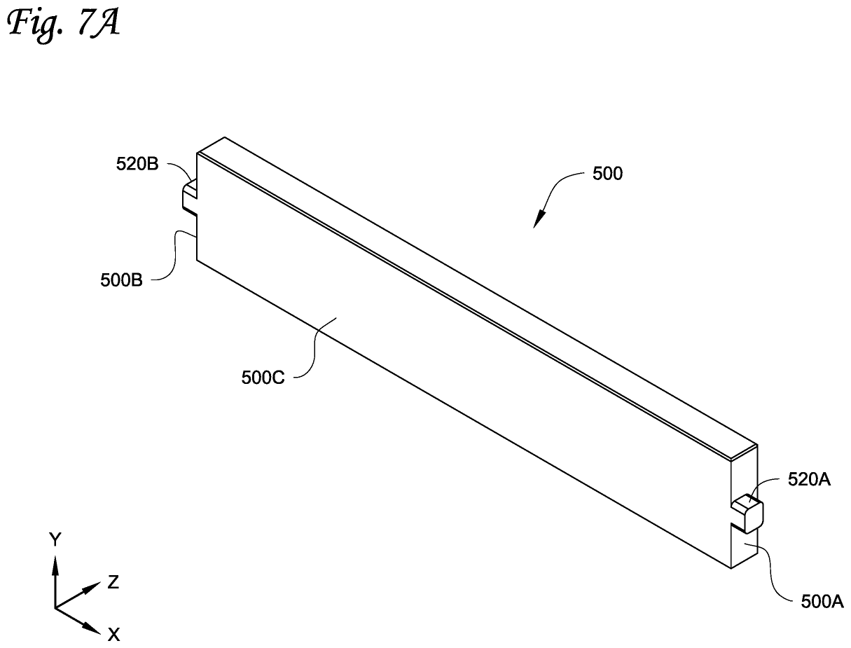

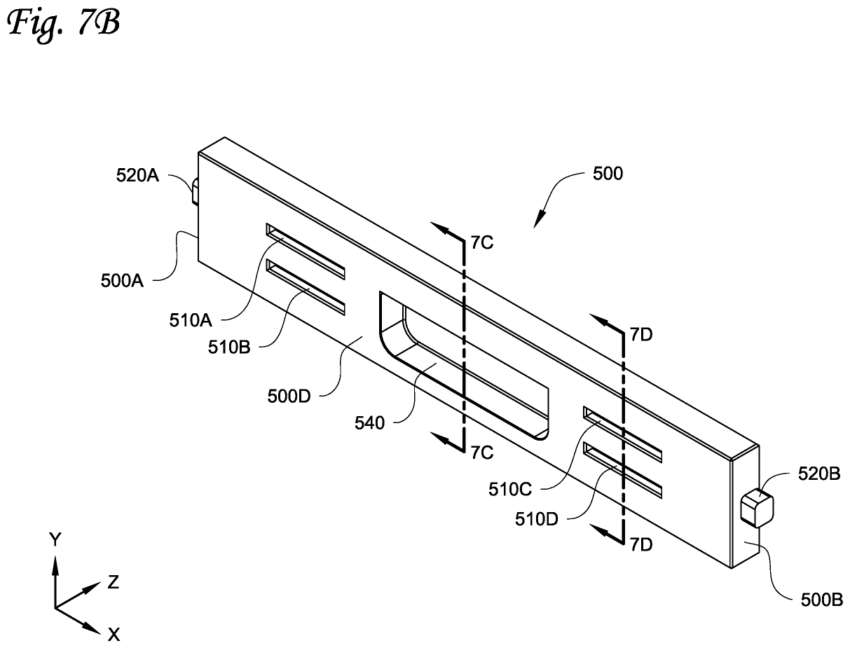

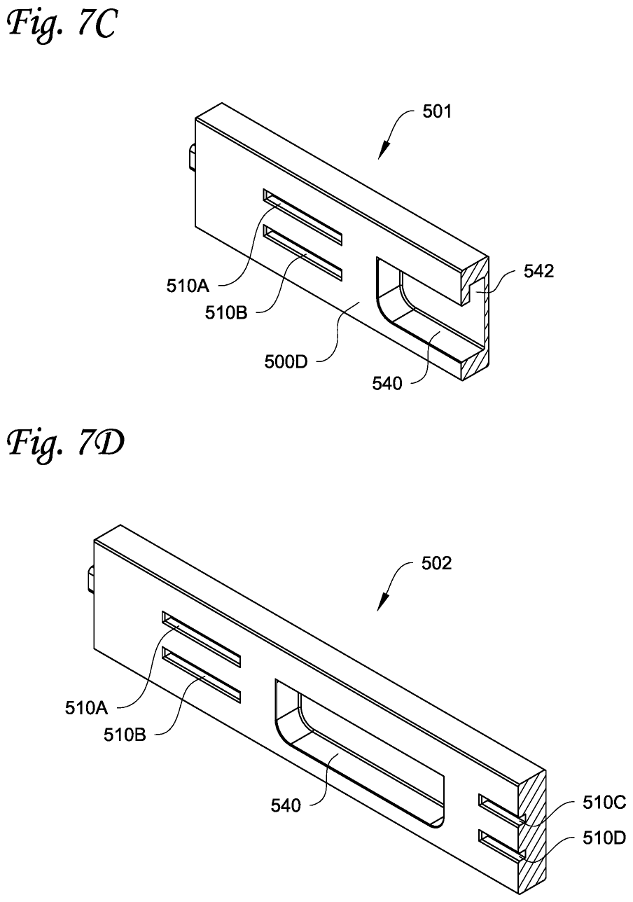

FIG. 7A illustrates a perspective view of a back end 500 of a frame (400, 500, 600A, 600B) of a bag holder 100, according to an embodiment. FIG. 7B is the back end 500 of FIG. 7A viewed at a different angle, according to an embodiment. FIG. 7C is a cross-sectional view 501 of the back end 500 of FIG. 7B along the line 7C-7C, according to an embodiment. FIG. 7D is a cross-sectional view 502 of the back end 500 of FIG. 7B along the line 7D-7D, according to an embodiment.

In an embodiment, the back end 500 can have a shape of a rectangular cuboid with protrusions (520A, 520B) extending from e.g., a middle portion of end surfaces (500A, 500B), respectively. The back end 500 includes a generally flat main surface 500C facing towards the enclosed space, and another main surface 500D opposite to surface 500C in the Z direction. The back end 500 also includes two end surfaces (500A, 500B) opposite to each other in the X direction.

In an embodiment, on the end 500A, the back end 500 includes a protrusion 520A protruding from e.g., a middle portion of the surface of the end 500A in X direction. On end 500B, the front end 500 includes a protrusion 520B protruding from e.g., a middle portion of the surface of the end 500B in X direction opposite to the protrusion 520A. In an embodiment, the protrusions (520A, 520B) can be identical to each other (and/or identical to the protrusions 420A, 420B) except the location and/or direction. In an embodiment, each protrusion (520A, 520B) can be a pin. The protrusion (520A, 520B) is configured to work with the side (600A, 600B) of the frame (to be described later).

In an embodiment, on the main surface 500D, the back end 500 includes recesses/slots (510A, 510B, 510C, 510D) extending in the width direction (X direction). The recesses (510A, 510B) are disposed away from the end 500A, overlap with each other in the width direction (X direction), and are in parallel with each other in the thickness direction (Y direction). Similarly, the recesses (510C, 510D) are disposed away from the end 500B, overlap with each other in the width direction (X direction), and are in parallel with each other in the thickness direction (Y direction).

It will be appreciated that in FIG. 4A, the distances between the sides (250C, 250D) and the arms (210A, 210B) correspond to the distances between the ends (500A, 500B) and the recesses (510A/510B, 510C/510D). In FIG. 4A, the distance between the arms (210A, 210B) corresponds to the distance between the recesses 510A/510B and the recesses 510C/510D. The lower recesses (510B, 510D) are configured to accommodate the arms (210A, 210B) of the bottom 200B. The upper recesses (510A, 510C) are configured to accommodate the arms (210A, 210B) of the cover 200A. See also FIG. 2A. For example, the lower recess 510B is configured to accommodate the second protrusion (Z-protrusion) of the arm 210B of the bottom 200B. The lower recess 510D is configured to accommodate the second protrusion (Z-protrusion) of the arm 210A of the bottom 200B. The upper recess 510A is configured to accommodate the second protrusion (Z-protrusion) of the arm 210B of the cover 200A. The upper recess 510C is configured to accommodate the second protrusion (Z-protrusion) of the arm 210A of the cover 200A. In an embodiment, the size, shape, and location of the recesses (510A, 510B) correspond to the size, shape, and location of the second protrusions (Z-protrusions) of the arms (210A, 210B) so that the arms (210A, 210B) can grab onto the back end 500 when being assembled, so that the bag holder 100 can provide desired retention on the back.

In an embodiment, the back end 500 includes a recessed portion 540 extending in the width direction (X direction) and disposed between the recesses (510A, 510B) and the recesses (510C, 510D) in the width direction (X direction). The recessed portion 540 is configured to facilitate users to grab/hold/handle the bag holder with their hands, when e.g., the bag holder 100 is in a box filled with dry-ice environment. In an embodiment, the recessed portion 540 can be identical to the recessed portion 440, except the location/direction.

As show in FIG. 7C, the recessed portion 540 has a retreated section 542 between the main surface 500D and the concaved surface of the recessed portion 540, to facilitate hand grabbing/holding/handling.

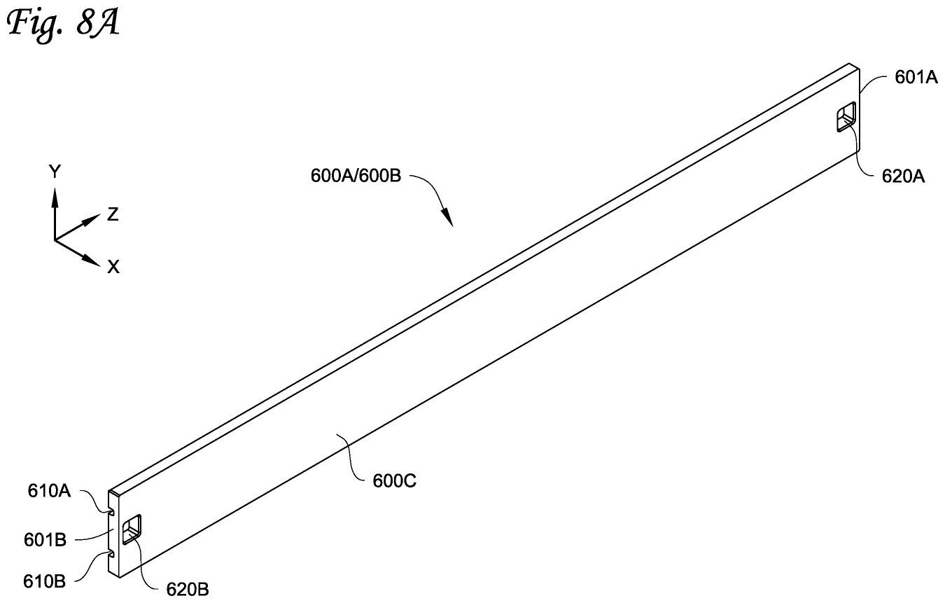

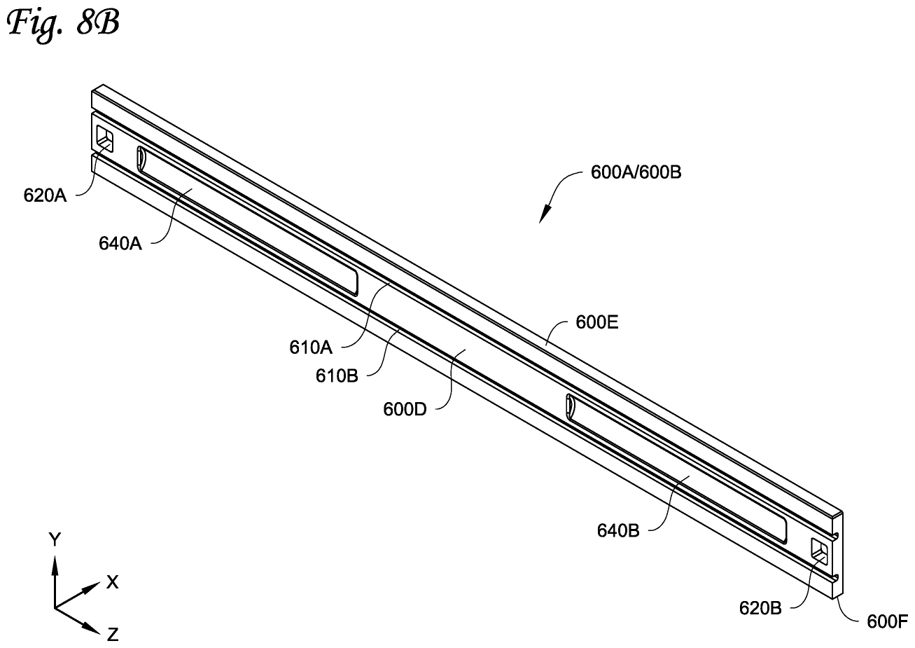

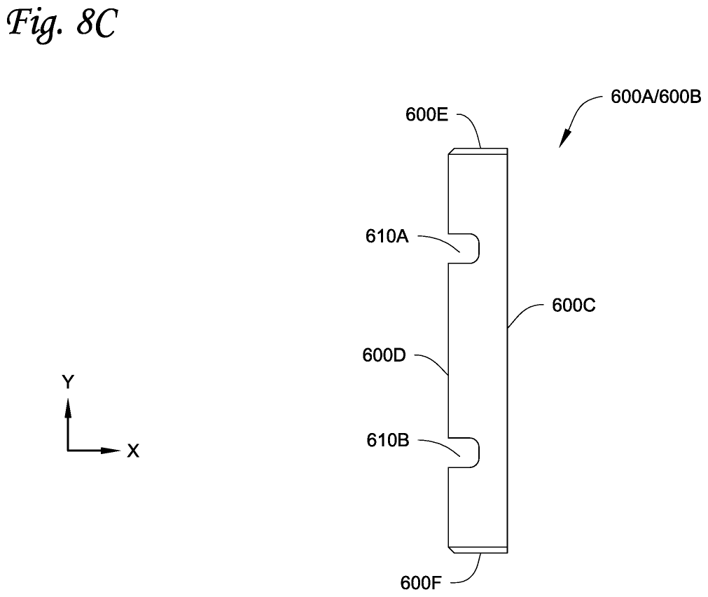

FIG. 8A illustrates a perspective view of a side (600A, 600B) of a frame of a bag holder, according to an embodiment. FIG. 8B is the side (600A, 600B) of FIG. 8A viewed at a different angle, according to an embodiment. FIG. 8C is an end view of the side (600A, 600B) of FIG. 8A, according to an embodiment.

In an embodiment, the side (600A, 600B) can have a shape of a rectangular cuboid. The side (600A, 600B) includes a generally flat main surface 600C facing towards the enclosed space, and another main surface 600D opposite to surface 600C in the X direction. The side (600A, 600B) also includes two end surfaces (601A, 601B) opposite to each other in the Z direction.

In an embodiment, near and away from the end 601A, the side (600A, 600B) includes a through hole 620A. Near and away from the end 601B, the side (600A, 600B) includes a through hole 620B. In an embodiment, the through holes can be identical to each other, except the location. Each of the through hole (620A, 620B) is configured to accommodate a protrusion/pin (420A, 420B) or (520A, 520B) of the front end 400 or back end 500. See FIGS. 1A and 1B and FIG. 2B. That is, the front end 400, the back end 500, and the sides (600A, 600B) can be lock together by inserting the protrusions/pins (420A/420B or 520A/520B) into corresponding through holes (620A, 620B), to form e.g., a rectangle frame or the like. The size, shape, and location of the protrusions/pins (420A/420B or 520A/520B) are configured/designed to correspond to the size, shape (e.g., rectangular shape or the like), and location of the through holes (620A, 620B).

In an embodiment, on the main surface 600D, the side (600A, 600B) includes longitudinal recesses (or grooves) (610A, 610B) extending from the end 601A to the end 601B in the longitudinal direction (Z direction). The longitudinal recesses (610A, 610B) can be identical to each other except the location. The longitudinal recess 610A is disposed near and spaced away from the top surface 600E of the side (600A, 600B). The longitudinal recess 610B is disposed near and spaced away from the bottom surface 600F of the side (600A, 600B). The longitudinal recesses (610A, 610B) are generally in parallel with each other in the Y direction.

In an embodiment, on the main surface 600D, the side (600A, 600B) includes recessed portions (640A, 640B) to facilitate hand grabbing/holding/handling, when e.g., the bag holder 100 is in a box filled with dry-ice environment. In an embodiment, the side (600A, 600B) can include at least one recessed portion (640A, 640B). In an embodiment, the recessed portions (640A, 640B) can be identical to each other (and/or identical to the recessed portion 440 or 540) except the location.

In an embodiment, the through holes (620A, 620B) and the recessed portions (640A, 640B) are disposed between the longitudinal recesses (610A, 610B) in the Y direction. The recessed portions (640A, 640B) are disposed between the through holes (620A, 620B) in the Z direction. The recessed portions (640A, 640B) are disposed in a side by side fashion in the Z direction.

The longitudinal recesses (610A, 610B) are configured to accommodate the second protrusions (X-protrusions) of the longitudinal arms (220A, 220B) of the cover/bottom (200A, 200B), so that the bag holder 100 can provide desired retention on the sides. The size, shape, and location of the longitudinal recesses (610A, 610B) are designed/configured to correspond to the size, shape, and location of the second protrusions (X-protrusions) of the longitudinal arms (220A, 220B) of the cover/bottom (200A, 200B). See also FIGS. 2B and 4A. For example, the second protrusion (X-protrusion) of the longitudinal arm 220B of the cover 200A can be accommodated in the longitudinal recesses 610A of the first side 600A. The second protrusion (X-protrusion) of the longitudinal arms 220A of the cover 200A can be accommodated in the longitudinal recesses 610A of the second side 600B. The second protrusion (X-protrusion) of the longitudinal arm 220A of the bottom 200B can be accommodated in the longitudinal recesses 610B of the first side 600A. The second protrusion (X-protrusion) of the longitudinal arms 220B of the bottom 200B can be accommodated in the longitudinal recesses 610B of the second side 600B. It will be appreciated that the cover 200A and the bottom 200B can be removably attached to the frame (400, 500, 600A, 600B) by the second protrusions (X-protrusions) of the longitudinal arms (220A, 220B) of the cover/bottom (200A, 200B) sliding through the longitudinal recesses (610A, 610B), e.g., from the end 601A to the end 601B (or from the end 601B to the end 601A).

In an embodiment, assembling the bag holder 100 includes inserting the protrusions/pins/side-pins (420A, 420B) of the front end 400 and/or the protrusions/pins/side-pins (520A, 520B) of the back end 500, into the corresponding through holes (620A, 620B) of the sides (600A, 600B). Assembling the bag holder 100 also includes sliding the longitudinal arms (220A, 220B) of the bottom 200B into the longitudinal recesses (610A, 610B) of the sides (600A, 600B). Assembling the bag holder 100 further includes inserting the arms (210A, 210B) of the bottom 200B into the recesses/slots (510A, 510B) of the back end 500. The inserting and the sliding steps can result in locking the frame (400, 500, 600A, 600B) together with the bottom 200B, forming e.g., a rectangular shaped frame (400, 500, 600A, 600B) on top of the bottom 200B, with the entire tabs (230A, 230B) of the bottom 200B protruding from the front end 400 in plan view.

In an embodiment, assembling the bag holder 100 also includes bending the tabs (230A, 230B) of the bottom 200B to cover the front end 400 so that the pins (430A, 430B) of the front end 400 penetrate the holes of the tabs (230A, 230B) of the bottom 200B. Assembling the bag holder 100 further includes installing the at least one bag support (300A, 300B, 302) into the enclosed space formed by the frame (400, 500, 600A, 600B) and the bottom 200B, with the open areas (310A, 310B) of the at least one bag support (300A, 300B, 302) overlapping with each other to form a space within the enclosed space for accommodating a bag. Installing the at least one bag support (300A, 300B, 302) into the enclosed space may not cause bowing on the at least one bag support (300A, 300B, 302).

In an embodiment, assembling the bag holder 100 also includes lining up the longitudinal arms (220A, 220B) of the cover 200A with the longitudinal recesses (610A, 610B) of the sides (600A, 600B), and sliding the longitudinal arms (220A, 220B) of the cover 200A into the longitudinal recesses (610A, 610B) of the sides (600A, 600B). Sliding the longitudinal arms (220A, 220B) of the cover 200A into the longitudinal recesses (610A, 610B) of the sides (600A, 600B) may not cause the at least one bag support (300A, 300B, 302) being gripped by the tabs (230A, 230B) of the cover 200A. It will be appreciated that more tabs may cause e.g., cut hazard to gloves, the bag, and/or other contact objects since metal bend tabs can be sharp. Assembling the bag holder 100 further includes inserting the arms (210A, 210B) of the cover 200A into the recesses/slots (510A, 510B) of the back end 500. The lining, sliding, and inserting steps can result in locking the frame (400, 500, 600A, 600B) together with the bottom 200B and the cover 200A, with the entire tabs (230A, 230B) of the cover 200A protruding from the front end 400 in plan view.

In an embodiment, assembling the bag holder 100 does not include bending the tabs (230A, 230B) of the cover 200A. Assembling the bag holder 100 can also include sealing (e.g., vacuum sealing or the like) the bag holder 100 (with the entire tabs (230A, 230B) of the cover 200A protruding from the front end 400 in plan view) in a container to avoid damage or gathering particulates during shipping.

It will be appreciated that when the user receives the bag holder 100, the user can perform steps including unsealing the container, removing the cover 200A, installing a bag in the open areas (310A, 310B) of the at least one bag support (300A, 300B, 302), sliding the longitudinal arms (220A, 220B) of the cover 200A back into the longitudinal recesses (610A, 610B) of the sides (600A, 600B), bending the tabs (230A, 230B) of the cover 200A, and/or installing a cable tie or the like through the through hole of the pin (430A, 430B) as a tamper evidence feature, or the like.

### ASPECTS

It is understood that any one of aspects 1-16 can be combined with any one of aspects 17-18 and 19-20. Any one of aspects 17-18 can be combined with any one of aspects 19-20.

Aspect 1. A bag holder for supporting a bioprocess bag during freezing, comprising: a cover, a bottom, and a frame; and at least one bag support, wherein the cover, the bottom, and the frame form an enclosed space; the at least one bag support is disposed in the space; the cover and the bottom are made of metal; the frame has a first side, a second side, a front end, and a back end; each of the cover and the bottom has a first bendable tab and a second bendable tab configured to bend over the front end from a longitudinal direction to a thickness direction, and a first arm and a second arm extending in the thickness direction and then in the longitudinal direction, the cover and the bottom are removably attached to the frame, the frame is disposed between the cover and the bottom, and each of the first side and the second side includes at least one recessed portion extending in the longitudinal direction.

Aspect 2. The bag holder of aspect 1, wherein the front end includes a first recess and a second recess extending in the thickness direction, the first recess is configured to accommodate the first tab of the cover and the first tab of the bottom, and the second recess is configured to accommodate the second tab of the cover and the second tab of the bottom.

Aspect 3. The bag holder of aspect 2, wherein the front end includes a first pin extending in the longitudinal direction from a concaved surface of the first recess, and a second pin extending in the longitudinal direction from a concaved surface of the second recess.

Aspect 4. The bag holder of aspect 3, wherein the first tab of the cover includes a first hole, the first pin is configured to penetrate the first tab of the cover through the first hole, the second tab of the cover includes a second hole, and the second pin is configured to penetrate the second tab of the cover through the second hole.

Aspect 5. The bag holder of aspect 3, wherein the first tab of the bottom includes a third hole, the first pin is configured to penetrate the first tab of the bottom through the third hole, the second tab of the bottom includes a fourth hole, and the second pin is configured to penetrate the second tab of the bottom through the fourth hole.

Aspect 6. The bag holder of aspect 3, wherein each of the first pin and the second pin includes a through hole.

Aspect 7. The bag holder of any one of aspects 1-6, wherein the cover and the bottom are made of stainless steel, and the frame is made of plastic.

Aspect 8. The bag holder of any one of aspects 1-7, wherein the frame is made of high density polyethylene.

Aspect 9. The bag holder of any one of aspects 1-8, wherein the front end includes a recessed portion extending in a width direction.

Aspect 10. The bag holder of aspect 9, wherein the front end includes a first recess and a second recess extending in the thickness direction, the recessed portion of the front end is disposed between the first recess and the second recess in the width direction.

Aspect 11. The bag holder of any one of aspects 1-10, wherein the back end includes a recessed portion extending in a width direction, the recessed portion of the back end is disposed between the first arm and the second arm of the cover in the width direction.

Aspect 12. The bag holder of any one of aspects 1-11, wherein the front end includes a first side pin extending in a width direction from a first side surface of the front end, and a second side pin extending in the width direction from a second side surface of the front end, the back end includes a first side pin extending in the width direction from a first side surface of the back end, and a second side pin extending in the width direction from a second side surface of the back end.

Aspect 13. The bag holder of any one of aspects 1-12, wherein the first side includes a first through hole and a second through hole, the second side includes a first through hole and a second through hole, the first through hole of the first side is configured to accommodate the first side pin of the front end, the first through hole of the second side is configured to accommodate the second side pin of the front end, the second through hole of the first side is configured to accommodate the first side pin of the back end, and the second through hole of the second side is configured to accommodate the second side pin of the back end.

Aspect 14. The bag holder of any one of aspects 1-13, wherein the at least one recessed portion of the first side includes two recessed portions arranged side by side along a length of the bag holder, and the at least one recessed portion of the second side includes two recessed portions arranged side by side along the length of the bag holder.

Aspect 15. The bag holder of any one of aspects 1-14, wherein the first side includes a first longitudinal recess and a second longitudinal recess arranged in parallel to each other, the second side includes a first longitudinal recess and a second longitudinal recess arranged in parallel to each other.

Aspect 16. The bag holder of aspect 15, wherein the cover includes a first longitudinal arm and a second longitudinal arm, the bottom includes a first longitudinal arm and a second longitudinal arm, the first longitudinal arm of the cover and the second longitudinal arm of the cover are configured to slide into the first longitudinal recess of the first side and the first longitudinal recess of the second side, respectively, and the first longitudinal arm of the bottom and the second longitudinal arm of the bottom are configured to slide into the second longitudinal recess of the first side and the second longitudinal recess of the second side, respectively.

Aspect 17. A bag holder for supporting a bioprocess bag during freezing, comprising: a cover, a bottom, and a frame; and at least one bag support having an aperture, wherein the cover, the bottom, and the frame form an enclosed space; the at least one bag support is disposed in the space; the cover and the bottom are made of metal; the frame has a first side, a second side, a front end, and a back end; each of the cover and the bottom has a first bendable tab and a second bendable tab configured to bend over the front end from a longitudinal direction to a thickness direction, and a first arm and a second arm extending in the thickness direction and then in the longitudinal direction, the cover and the bottom are removably attached to the frame, the frame is disposed between the cover and the bottom, each of the first side and the second side includes at least one recessed portion extending in the longitudinal direction, and the bioprocess bag is disposed in the aperture.

Aspect 18. The bag holder of aspect 17, wherein the bioprocess bag is made of fluoropolymer.

Aspect 19. A method of assembling a bag holder for freezing of a bioprocess bag; the bag holder including a cover, a bottom, a frame, and at least one bag support; the frame having a first side, a second side, a front end, and a back end; the method comprising: inserting side pins of the front end and side pins of the back end into through holes of the first side and through holes of the second side; sliding the frame so that side arms of the bottom slide into a first longitudinal recess of the first side and a first longitudinal recess of the second side; bending tabs of the bottom into recesses of the front end so that pins of the front end penetrate the tabs of the bottom via holes of the tabs of the bottom; deploying at least one bag support into a space enclosed by the bottom and the frame; and sliding the cover so that side arms of the cover slide into a second longitudinal recess of the first side and a second longitudinal recess of the second side.

Aspect 20. The method of aspect 19, further comprising: inserting the bag holder into a package; and vacuum sealing the package containing the bag holder.

The examples disclosed in this application are to be considered in all respects as illustrative and not limitative. The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A bag holder for supporting a bioprocess bag during freezing, comprising:
a cover, a bottom, and a frame; and
at least one bag support,
wherein the cover, the bottom, and the frame form an enclosed space;
the at least one bag support is disposed in the space;
the cover and the bottom are made of metal;
the frame has a first side, a second side, a front end, and a back end;
each of the cover and the bottom has a first bendable tab and a second bendable tab configured to bend over the front end from a longitudinal direction to a thickness direction, and a first arm and a second arm extending in the thickness direction and then in the longitudinal direction,
the cover and the bottom are removably attached to the frame, the frame is disposed between the cover and the bottom, and
each of the first side and the second side includes at least one recessed portion extending in the longitudinal direction.

2. The bag holder of claim 1, wherein the front end includes a first recess and a second recess extending in the thickness direction,
the first recess is configured to accommodate the first tab of the cover and the first tab of the bottom, and
the second recess is configured to accommodate the second tab of the cover and the second tab of the bottom.

3. The bag holder of claim 2, wherein the front end includes a first pin extending in the longitudinal direction from a concaved surface of the first recess, and a second pin extending in the longitudinal direction from a concaved surface of the second recess.

4. The bag holder of claim 3, wherein the first tab of the cover includes a first hole, the first pin is configured to penetrate the first tab of the cover through the first hole,
the second tab of the cover includes a second hole, and the second pin is configured to penetrate the second tab of the cover through the second hole.

5. The bag holder of claim 3, wherein the first tab of the bottom includes a third hole, the first pin is configured to penetrate the first tab of the bottom through the third hole,
the second tab of the bottom includes a fourth hole, and the second pin is configured to penetrate the second tab of the bottom through the fourth hole.

6. The bag holder of claim 3, wherein each of the first pin and the second pin includes a through hole.

7. The bag holder of claim 1, wherein the cover and the bottom are made of stainless steel, and the frame is made of plastic.

8. The bag holder of claim 1, wherein the frame is made of high density polyethylene.

9. The bag holder of claim 1, wherein the front end includes a recessed portion extending in a width direction.

10. The bag holder of claim 9, wherein the front end includes a first recess and a second recess extending in the thickness direction,
the recessed portion of the front end is disposed between the first recess and the second recess in the width direction.

11. The bag holder of claim 1, wherein the back end includes a recessed portion extending in a width direction,
the recessed portion of the back end is disposed between the first arm and the second arm of the cover in the width direction.

12. The bag holder of claim 1, wherein the front end includes a first side pin extending in a width direction from a first side surface of the front end, and a second side pin extending in the width direction from a second side surface of the front end,
the back end includes a first side pin extending in the width direction from a first side surface of the back end, and a second side pin extending in the width direction from a second side surface of the back end.

13. The bag holder of claim 1, wherein the first side includes a first through hole and a second through hole, the second side includes a first through hole and a second through hole,
the first through hole of the first side is configured to accommodate the first side pin of the front end,
the first through hole of the second side is configured to accommodate the second side pin of the front end,
the second through hole of the first side is configured to accommodate the first side pin of the back end, and
the second through hole of the second side is configured to accommodate the second side pin of the back end.

14. The bag holder of claim 1, wherein the at least one recessed portion of the first side includes two recessed portions arranged side by side along a length of the bag holder, and
the at least one recessed portion of the second side includes two recessed portions arranged side by side along the length of the bag holder.

15. The bag holder of claim 1, wherein the first side includes a first longitudinal recess and a second longitudinal recess arranged in parallel to each other,
the second side includes a first longitudinal recess and a second longitudinal recess arranged in parallel to each other.

16. The bag holder of claim 15, wherein the cover includes a first longitudinal arm and a second longitudinal arm,
the bottom includes a first longitudinal arm and a second longitudinal arm,
the first longitudinal arm of the cover and the second longitudinal arm of the cover are configured to slide into the first longitudinal recess of the first side and the first longitudinal recess of the second side, respectively, and
the first longitudinal arm of the bottom and the second longitudinal arm of the bottom are configured to slide into the second longitudinal recess of the first side and the second longitudinal recess of the second side, respectively.

17. A bag holder for supporting a bioprocess bag during freezing, comprising:
a cover, a bottom, and a frame; and
at least one bag support having an aperture,
wherein the cover, the bottom, and the frame form an enclosed space;
the at least one bag support is disposed in the space;
the cover and the bottom are made of metal;
the frame has a first side, a second side, a front end, and a back end;
each of the cover and the bottom has a first bendable tab and a second bendable tab configured to bend over the front end from a longitudinal direction to a thickness direction, and a first arm and a second arm extending in the thickness direction and then in the longitudinal direction,
the cover and the bottom are removably attached to the frame, the frame is disposed between the cover and the bottom,
each of the first side and the second side includes at least one recessed portion extending in the longitudinal direction, and
the bioprocess bag is disposed in the aperture.

18. The bag holder of claim 17, wherein the bioprocess bag is made of fluoropolymer.

19. A method of assembling a bag holder for freezing of a bioprocess bag; the bag holder including a cover, a bottom, a frame, and at least one bag support; the frame having a first side, a second side, a front end, and a back end; the method comprising:
inserting side pins of the front end and side pins of the back end into through holes of the first side and through holes of the second side;
sliding the frame so that side arms of the bottom slide into a first longitudinal recess of the first side and a first longitudinal recess of the second side;
bending tabs of the bottom into recesses of the front end so that pins of the front end penetrate the tabs of the bottom via holes of the tabs of the bottom;
deploying at least one bag support into a space enclosed by the bottom and the frame; and
sliding the cover so that side arms of the cover slide into a second longitudinal recess of the first side and a second longitudinal recess of the second side.

20. The method of claim 19, further comprising:
inserting the bag holder into a package; and
vacuum sealing the package containing the bag holder.
